(19) United States
(12) Patent Application Publication
(10) Pub. No.: US 2026/0139988 A1
(43) Pub. Date: May 21, 2026

(54) Method and Apparatus For Sensing and Indicating Fluid Level in Fluid Storage Vessels

(71) Applicant: Digital Milkshake Technologies LLC, Lake In The Hills, IL (US)

(72) Inventors: Dean A Kostan, Lake In The Hills, IL (US); Marvin Evans, Shorewood, IL (US); Kate Kostan, Lake In The Hills, IL (US)

(73) Assignee: Digital Milkshake Technologies LLC, Lake In The Hills, IL (US)

(21) Appl. No.: 19/390,929

(22) Filed: Nov. 17, 2025

Related U.S. Application Data
(60) Provisional application No. 63/722,835, filed on Nov. 20, 2024.

(51) Int. Cl. G01F 23/263

(52) U.S. Cl. CPC G01F 23/266

(57) ABSTRACT

A method and apparatus for sensing and indicating fluid levels in a fluid storage vessel. The device provides the fluid storage vessel and uses measurements from a plurality of sensor plates to create a reading of how much liquid is in the fluid storage vessel. A comparison of this reading is conducted to the level of the fluid storage vessel, when full, to determine how much liquid is in the fluid storage vessel. And, colors are then assigned to various levels of liquid and the fluid storage vessel is illuminated with the assigned color.

### I. CROSS-REFERENCE TO RELATED APPLICATION

This patent application is a non-provisional application claiming priority from U.S. Provisional Patent Application Ser. No. 63/722,835, entitled “Method and Apparatus For Sensing and Indicating Fluid Level In Fluid Storage Vessels”, filed on Nov. 20, 2024, and is fully incorporated herein by reference.

### II. FIELD OF THE INVENTION

The present invention relates to a fluid sensing and indicating system and, more particularly, to a method and apparatus for sensing and indicating the fluid level in drinking glasses and/or any other fluid storage vessels.

### III. SUMMARY OF THE INVENTION

The present invention is a method and apparatus for sensing and indicating fluid levels in a fluid storage vessel. The device provides the fluid storage vessel and uses measurements from a plurality of sensor plates to create a reading of how much liquid is in the fluid storage vessel. A comparison of this reading is conducted to the level of the fluid storage vessel, when full, to determine how much liquid is in the fluid storage vessel. And, colors are then assigned to various levels of liquid and the fluid storage vessel is illuminated with the assigned color.

### IV. BRIEF DESCRIPTION OF THE DRAWINGS

The Description of the Preferred Embodiment will be better understood with reference to the following figures:

FIG. 1 is a perspective view of Applicant's inventive fluid storage vessel.

FIG. 2 is a schematic of the internal components of Applicant's inventive fluid storage vessel.

FIG. 3 is a top perspective view (including protective pattern shield facing the exterior) and bottom perspective view (including the dual sensor(s) facing the interior) of the level sensor in Applicant's inventive fluid storage vessel.

FIG. 4 is a schematic flow diagram of the interaction between the internal components of Applicant's inventive fluid storage vessel.

### V. DETAILED DESCRIPTION OF THE PREFERRED EMBODIMENT

While this invention is susceptible of embodiment in many different forms, there is shown in the drawings and described herein in detail specific embodiments with the understanding that the present disclosure is to be considered as an exemplification of the principles of the invention and is not intended to limit the invention to the embodiments illustrated.

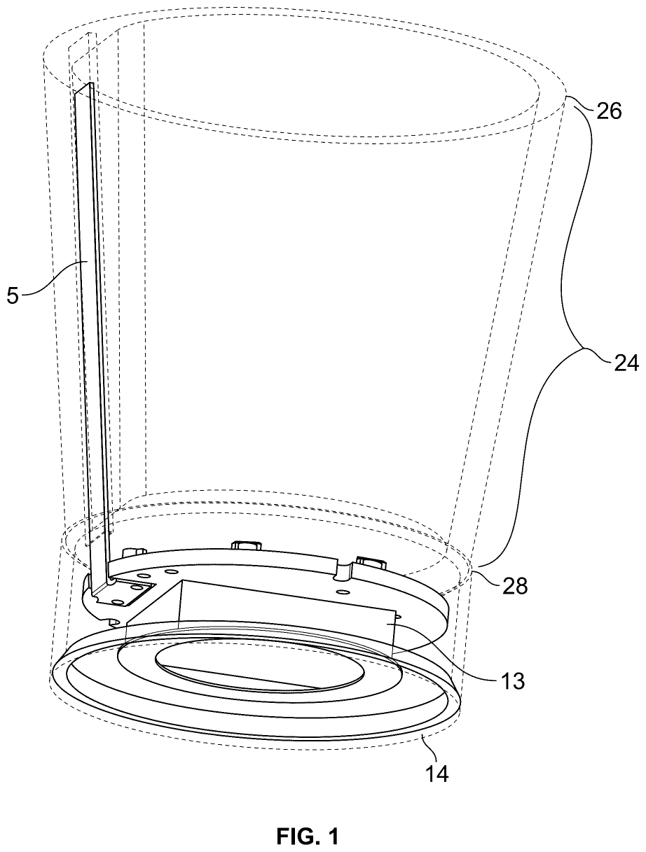

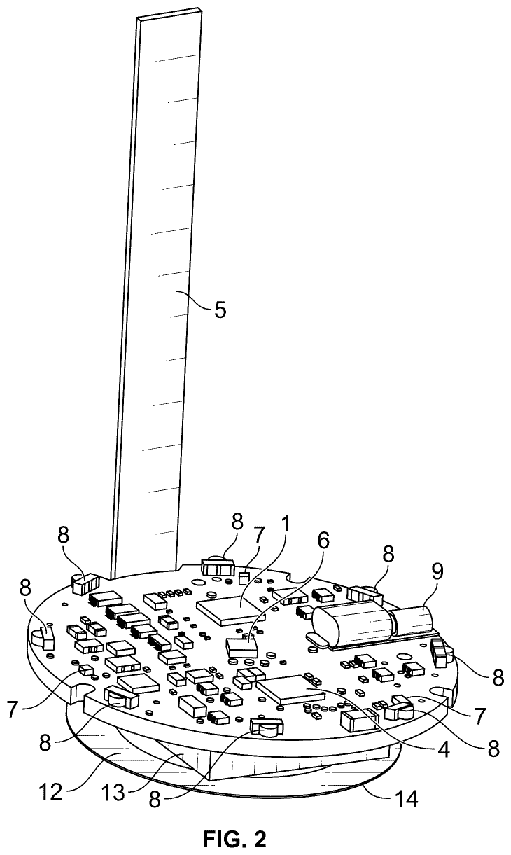

It will be understood that like or analogous elements and/or components, referred to herein, may be identified throughout the drawings with like reference characters. It will be further understood that FIGS. 1-9 are merely schematic representations of the device and some of the components may have been distorted from their actual scale for pictorial clarity.

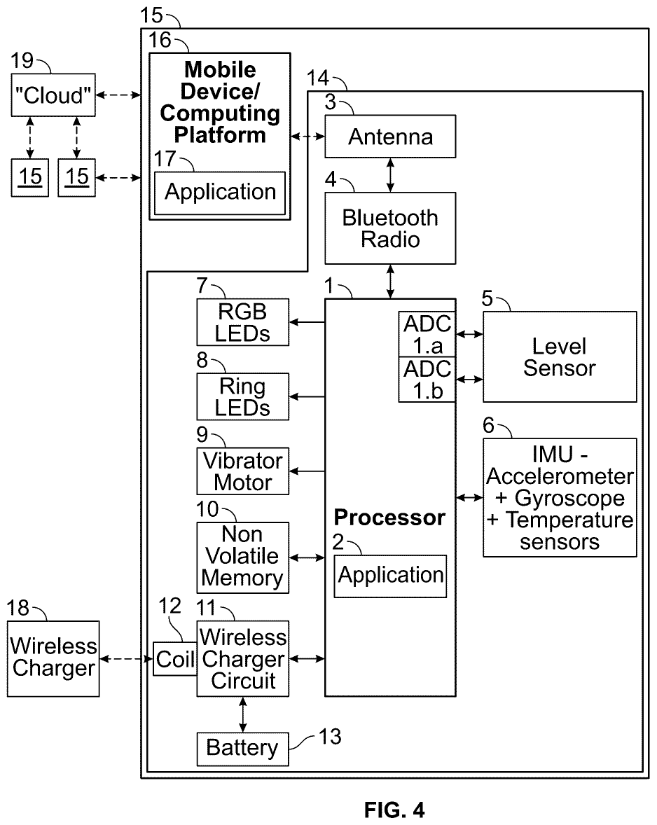

In accordance with the present invention, Applicant's invention consists of the interaction between a drinking glass and/or any other fluid storage vessel 14, as illustrated in FIGS. 1 through 3; and the interaction of the internal components of the fluid storage vessel 14 and/or unique system 20 used in connection with the fluid storage vessel 14, as illustrated in FIG. 4.

As illustrated in FIGS. 1 through 4, and in the preferred embodiment, Applicant's fluid storage vessel 14 comprises a processor 1 (e.g., in the preferred embodiment, the processor 1 is a PIC16LF1567, or any other processor known to one skilled in the art that can accomplish Applicant's invention disclosed herein, with downward migration to part with less mem 354, or any other processor that is known to one skilled in the art that can accomplish Applicant's invention); an application 2; an antenna 3; a Bluetooth 4 (e.g., a BLE module, preferably Nordic Semiconductor nRF52833, or any other BLE module known to one skilled in the art that can accomplish Applicant's invention disclosed herein); a level sensor 5 including analog to digital converters; an inertial measurement unit (IMU) 6 that contains an accelerometer, a gyroscope, and a temperature sensor; light emitting diodes 7 (e.g., in the preferred embodiment, the light emitting diode 7 are three efficient RGB (red, green, blue) light emitting diodes situated at 120 degree separation around the periphery of the fluid storage vessel 14); light emitting diode 8 or ring light emitting diode 8 (e.g., in the preferred embodiment, the light emitting diodes 8 are eight efficient light emitting diodes situated at 45 degree separation, that form a ring, around the periphery of the fluid storage vessel 14); a vibration motor device 9; a non-volatile memory (NVM) 10; a wireless charger circuit 11; a coil 12; a battery 13 for powering the fluid storage vessel 14; external devices 15 for use in connection with the cloud 19 and fluid storage vessel 14; a mobile device/computing platform 15, an application 17 for use in connection with the mobile device/computing platform 15 and the external devices 15 and cloud 19; and a wireless charger 18 for recharging the battery 13 and/or powering the fluid storage vessel electronics 14.

Alternatively, as the various components and the communication between them are well known in the art, it is also contemplated that any computer hardware or components, compatible type, version, or size made by any manufacturer is acceptable as the computer hardware or components to accomplish the intended purposes of Applicant's invention.

Applicant's inventive fluid storage vessel 14 and operation is described in more detail below.

In the preferred embodiment, the fluid storage vessel 14 operation is fully autonomous is that it contains no external switches or other external mechanisms to control the power or other functions of the fluid storage vessel 14. To accomplish this control, Applicant's inventive fluid storage vessel 14 utilizes the internal components coacting with the interaction/movements of the fluid storage vessel 14 by or with the user.

The fluid storage vessel 14 is turned “on” or activates, and the processor 1 boots up, when the fluid storage vessel 14 is placed on the wireless charger 18, or when the IMU 6 is configured by the processor 1 to power board upon motion of the fluid storage vessel 14. In a non-limiting example, the motion or movement of the fluid storage vessel 14 is recorded/detected, using the accelerometer or gyroscope of the inertial measurement unit (IMU) 6 to record the x/y/z linear and rotational movement of the fluid storage vessel 14, and once that motion or movement exceeds a predefined threshold, it activates the processor 1 and turns on the fluid storage vessel 14.

The fluid storage vessel 14 is turned “off” or deactivates after a duration of inactivity exceeds or reaches a pre-defined or pre-programmed/settable timer setting that is stored in the NVM 1. When this occurs, the processor 1 enters a power down state to conserve the battery 13.

Once the fluid storage vessel 14 is turned “on” or activated, the processor 1 then operates continuously performing or executing many operations.

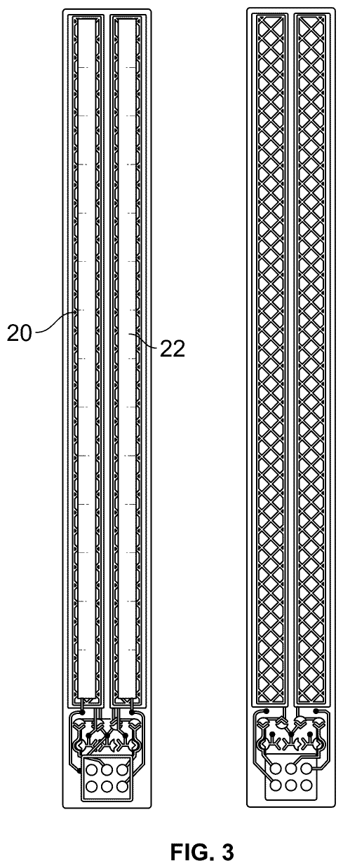

A measurement of the level of fluid level in the fluid storage vessel 14 is continuously performed and accomplished using the level sensor 5. In the preferred embodiment, a series of differential projected capacitive (DPCAP) using general purpose outputs of the processor 1 to charge each of the sensor plates 20 and 22 (see FIG. 3) in the level sensor 5 (see FIG. 3) is performed. Then, two analog to digital converters (ADCs) 1a and 1b (e.g., one for each of the sensor plates 20 and 22) are used to simultaneously measure the rate of decay to determine the capacitance introduced by the liquid level. In this manner, these dual simultaneous measurements allow common mode noise (e.g., electrical interference) to be better rejected. The samples are filtered and averages between the dual simultaneous measurements are used to produce a liquid level reading 24 (e.g., which will be somewhere along the fluid storage vessel 14) that can be compared against a calibrated full liquid level reading 26 to determine the level of the liquid within the fluid storage vessel 14 (e.g., between the empty liquid level 28 and full liquid level 26), which is generally a linear response over the length of the sensor plates 20 and 22 of the level sensor 5. In the preferred embodiment, the liquid level reading 24 is a percentage of the total calibrated full liquid level reading 26. For example, if the liquid level reading 24 was “35%”, this would represent that the level of liquid in the fluid storage vessel 14 is filled up to 35% of the total 100% available within the fluid storage vessel 14.

Based on the resulting liquid level reading 24, the fluid storage vessel 14 is illuminated. In the preferred embodiment, a color is assigned to each specific liquid level reading 24 or thresholds of the liquid level reading 24 from greater than 0 (e.g., almost empty) up to 100% (e.g., full). In a non-limiting example, the color for a liquid level reading 24 from greater than 0 up to 33% may be blue, the color for a liquid level reading 24 greater than 33% and up to 55% may be red, and the color for a liquid level reading 24 greater than 55% and up to 100% (e.g., full) may be green.

In this manner, if, using the non-limiting example above, the liquid level reading 24 is “35%”, this liquid level reading 24 is compared to the thresholds of liquid level readings 24 and associated color(s) stored in the NVM 10 resulting in the color red (e.g., where the color for a liquid level reading 24 greater than 33% and up to 55% may is red) and the light emitting diodes 7 would then illuminate the fluid storage vessel 14 red.

In another non-limiting example, if the fluid storage vessel 14 is being filled up with a liquid (e.g., such as from the tap of a beer keg), as the liquid or beer, in this case, is filling the fluid storage vessel 14, and since the measurement of the level of fluid level in the fluid storage vessel 14 is continuously performed, as the beer is filled into the fluid storage vessel 14 and when the liquid level reading 24 is greater than 0 (e.g., almost empty) up to 33%, the light emitting diodes 7 would then illuminate the fluid storage vessel 14 blue (e.g., if the color for a liquid level reading 24 from greater than 0 up to 33% is blue), the light emitting diodes 7 would then illuminate the fluid storage vessel 14 red (e.g., if the color for a liquid level reading 24 greater than 33% and up to 55% is red), and the light emitting diodes 7 would then illuminate the fluid storage vessel 14 green (e.g., if the color for a liquid level reading 24 greater than 55% and up to 100% (e.g., full) is green.

Additionally, the external devices 17 could be used to take priority over the thresholds of liquid level readings 24 and associated color(s) stored in the NVM 10, in which case, the external device 17 would control the light emitting diodes 7 and display any desired color, directly through the interfacing with the antenna 3 and Bluetooth 4 with the fluid storage vessel 14. Preferably, the external devices 17 also have access to all the sensor readings and the ability to update the glass firmware and certain NVM 10 settings/content).

To obtain the calibrated full liquid level reading 26, the fluid storage vessel 14 is run through any desired pre-programmed sequence and the inertial measurement unit (IMU) 6 with readings of the accelerometer and/or the gyroscope, or both, being used to determine when to perform start a calibration sequence. With 0% fluid in the fluid storage vessel 14, an empty level is determined. The fluid storage vessel 14 is filled up to 100% and a full level is determined. The difference between the empty level and the full level are stored and then used as calibration values to compute the liquid level from the level sensor readings 26.

Additionally, the inertial measurement unit IMU 6 sensors (e.g., x/y/z accelerometers, x/y/z gyroscopes, and/or temperature) can be used for many operations and/or uses with the fluid storage vessel 14:

As the inertial measurement unit IMU 6 sensors (e.g., x/y/z accelerometers, x/y/z gyroscopes, and/or temperature) are continuously creating a history of activity of the fluid storage vessel 14 (e.g., such as orientation change events, rotational change events, etc.), allowing threshold comparisons to be performed.

The inertial measurement unit IMU 6 sensors (e.g., x/y/z accelerometers, x/y/z gyroscopes, and/or temperature) may also be used to trigger a calibration, trigger a factory reset or system default reset, and/or any other functions desired. In the preferred embodiment, the fluid storage vessel 14 is run through any desired pre-programmed sequence for that specific event to trigger any of these events.

For example, to trigger a calibration, the fluid storage vessel 14 could, in a non-limiting example, be run through the following sequence: of a standard x y z axis (below)

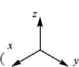

and using the z-axis orientation (e.g., with the fluid storage vessel 14 in the vertical “right-side up” orientation), rotate the fluid storage vessel 14 upside-down (e.g., vertical “upside down” orientation) and hold for some time period (e.g., 14 seconds for example); rotate the fluid storage vessel 14 back to right-side up orientation and hold for some time period (e.g., 7 seconds for example); rotate the fluid storage vessel 14 upside-down (e.g., vertical “upside down” orientation) and hold for some time period (e.g., 7 seconds for example); and then rotate the fluid storage vessel 14 back to right-side up orientation and hold for some time period (e.g., 7 seconds for example). Collectively, all of these rotations or movements of the fluid storage vessel 14 are referred to as “sequences” and “time durations.” In this manner, deliberate manipulation of the fluid storage vessel 14 through these sequences and time durations allows autonomous triggering of any desired event.

Alternatively, any of these event(s) may also be initiated using the external devices 17 through a command or through directly interfacing with the antenna 3 and Bluetooth 4 to the fluid storage vessel 14.

Checking the inactivity timer to see if level, motion, orientation, or Bluetooth commands have not been received in a programmable time period (e.g., with setting stored in NVM 10) and if so the processor 1 enters the power down state after configuring the IMU 6 to re-wake the processor 1 on motion. Note the that the processor 1 is always woken when the fluid storage vessel 14 is placed on the wireless charger or pad 18 so the fluid storage vessel 14 can always recover in the event of a dead battery 13 or some glitch in operation where the IMU 6 is not programmed to enable power to the processor 1 on a motion event.

Control idle state operation of the light emitting diodes 7. When the light emitting diodes 7 are not controlled by an external application 17 and, not currently detecting liquid or fluid in the fluid storage vessel 14, the light emitting diodes 7 will fade (e.g., fade out or “turn off” or fade up and “turn on”) with a certain rate and period between fade cycle using settings stored in the NVM (10).

Additionally, while in this fade mode, upon detection of certain rotational events, such as clockwise or counterclockwise rotation of the fluid storage vessel 14 or any other desired rotational event of the fluid storage vessel 14, the user can change the fade code by sequencing through a user settable color palette stored in NVM (10) (e.g., per each desired rotational event or “flick” rotation). In this manner, the user may use this rotational event or “flick” rotation to cycle through the stored settable color palette and set the fade mode to a specific color to set the “mood” or other indication for desired color. All of this is easy for the user to do autonomously without the need for an external device (15,16,17,19) and/or possibly through Bluetooth (3,4). Alternatively, it is contemplated that the use of any desired rotational event or “flick” rotation may be used for any other rotational event desired.

Controlling the vibration motor device 9. In the preferred embodiment, the vibration motor device 9 is used to vibrate or create a pulse in the fluid storage vessel 14. In a non-limiting example, the vibration motor device 9 may initiate a vibration or pulse upon completion of any desired sequence (e.g., such as the fluid storage vessel 14 starts in the vertical “right-side up” orientation and the liquid level reading 24 is 100% or full); rotate the fluid storage vessel 14 upside-down (e.g., vertical “upside down” orientation where the liquid level reading 24 becomes 0% or is emptied); and then the fluid storage vessel 14 is rotated back to the vertical “right-side up” orientation and the liquid level reading 24 remains at 0% or empty). Collectively, all of these rotations or movements of the fluid storage vessel 14 are referred to as “sequences” and “corresponding liquid level reading settings.” In this manner, deliberate manipulation of the fluid storage vessel 14 through these sequences and corresponding liquid level reading settings allows autonomous triggering of a vibration or pulse in the fluid storage vessel 14.

In this non-limiting example, these “sequences” and “corresponding liquid level reading settings” could be referred to as the “shot completion vibration or pulse”—the fluid storage vessel 14 is filled with a shot of something (e.g., could be favorite alcohol or non-alcoholic drink). This is the fluid storage vessel 14 starting in the vertical “right-side up” orientation and the liquid level reading 24 is 100% or full). The shot is then consumed by the user. This is the rotation of the fluid storage vessel 14 “upside down” orientation where the liquid level reading 24 becomes 0% or is emptied upon the shot being consumed by the user. Then, the fluid storage vessel 14 is rotated back to the vertical “right-side up” orientation and the liquid level reading 24 remains at 0% or empty. Once this complete sequence occurs, the vibration or pulse in the fluid storage vessel 14 is initiated. The process could then repeat itself if the user takes a second shot, and additionally, the application 2 could be programmed to initiate two vibrations or pulses in the fluid storage vessel 14 corresponding to each of the two shots.

During this complete sequence, the light emitting diodes or ring light emitting diodes 8 could likewise illuminate the fluid storage vessel 14 any desired color at the same time as the vibrations or pulses in the fluid storage vessel 14 are occurring. Thus, in the preferred embodiment, the fluid storage vessel 14 allows and can be programmed for any combination of vibration or pulses and lighting of the fluid storage vessel 14.

Also, the vibration motor device 9 may likewise receive indications from any external source (15,16,17,19) as well.

Checking charging status and control of charging indication. This occurs when the fluid storage device 14 is on wireless charger or pad (18) and the fluid storage device 14 displays the charging status as either (a) periodic fading in/out red on RGB LEDs (7), or (b) solid green to indicate fully charged. Alternatively, this may also occur when the fluid storage device 14 is on the wireless charger or pad 18 and the fluid storage device 14 takes control of LEDs and vibrator motor (9) regardless of external device's (16,17) requests to control such resources. However, the fluid storage device 14 provides a readable status of the charging through the Bluetooth interface (3,4) including all sensor values.

Check/detect user request to calibrate the fluid storage device 14 by monitoring values, as disclosed above, to initiate a calibration sequence if requested by the user.

Check/monitor temperature and shutdown unit in the event of out of range temperature.

Track full to upside down to right side up and empty event (i.e., glass filled, then emptied through drinking) events and maintain a counter that is backed up in NVM (10) so that lifetime use can be tracked and read through the Bluetooth interface (3,4) by an external device (16,17,19, other 15s).

Check, process, and acknowledge commands received from an external entity (16,17, other 15's) through the Bluetooth interface (3,4) or indirectly through the cloud (15).

Applicant's invention and fluid storage vessel 14 provides many benefits and anticipated uses. The fluid storage vessel 14: (i) is designed to be very functional in an “autonomous”, not *requiring* an external app for most features; (b) provides enhanced functionality with the use of a mobile application to fully customize the fluid storage vessel 14 (colors, light emitting diode (LED) effects); (c) may serve as a drinking (and other game) device when used with the correct mobile application software or on board embedded software; (d) is scalable in any size and incorporate or use various form factor vessels; (e) supports control of the ring light emitting diode 8 (LEDs) for game functionality and various visually pleasing operations such as spinning, direction indication, counting, etc.; and (f) provides Bluetooth functionality including location/finding functions, direction ranging capability to/from external mobile devices (15) and other glasses (14).

Lastly, as the light emitting diodes 7 and ring light emitting diodes 8 are used to illuminate the fluid storage vessel 14, in the same manner, ultraviolet lights may also be used to illuminate the fluid storage vessel 14 to self-sterilize the fluid storage vessel 14.

Thus, there has been provided Applicant's unique method and apparatus for sensing and indicating the fluid level in drinking glasses and/or any other fluid storage vessels. While the invention has been described in conjunction with a specific embodiment, it is evident that many alternatives, modifications and variations will be apparent to those skilled in the art in light of the foregoing description. Accordingly, it in intended to embrace all such alternatives, modifications and variations as fall within the spirit and scope of the disclosure contained herein and appended claims.

What is claimed is:

1. A method for indicating fluid level in a fluid vessel, comprising the steps of:
using measurements provided by a plurality of sensor plates to create a liquid level reading;
providing a full liquid level reading of the fluid vessel; and
comparing the liquid level reading to the full liquid level reading to determine a first level of liquid within the fluid vessel.

2. The method of claim 1 and further comprising the step of assigning a color to the first level of liquid within the fluid vessel comprising the steps of:
(i) if the first level of liquid within the fluid vessel is between zero percent and up to thirty-three percent, assigning a first color;
(ii) if the first level of liquid within the fluid vessel is greater than thirty-three percent and up to fifty-five percent, assigning a second color;
(iii) if the first level of liquid within the fluid vessel is greater than fifty-five percent and up to one-hundred percent, assigning a third color.

3. The method of claim 2 and further comprising the step of illuminating the fluid vessel with the one of the first color, the second color, and the third color.

4. The method of claim 3 and further comprising the step of continuously measuring the fluid level in the fluid vessel and determining a second level of liquid within the fluid vessel.

5. The method of claim 4 and further comprising the step of updating the assigning of the color to the second level of liquid within the fluid vessel.

6. The method of claim 5 and further comprising the step of changing the illuminating the fluid vessel with the one of the first color, the second color, and the third color based on the second level of liquid within the fluid vessel.

7. A method for indicating fluid level in a fluid vessel, comprising the steps of:
measuring the fluid level in the fluid vessel comprising the steps of:
(i) using measurements provided by a plurality of sensor plates to create a liquid level reading;
(ii) providing a full liquid level reading of the fluid vessel;
(iii) comparing the liquid level reading to the full liquid level reading to determine a first level of liquid within the fluid vessel;
assigning a color to the first level of liquid within the fluid vessel comprising the steps of:
(iv) if the first level of liquid within the fluid vessel is between zero percent and up to thirty-three percent, assigning a first color;
(v) if the first level of liquid within the fluid vessel is greater than thirty-three percent and up to fifty-five percent, assigning a second color;
(vi) if the first level of liquid within the fluid vessel is greater than fifty-five percent and up to one-hundred percent, assigning a third color;
illuminating the fluid vessel with the one of the first color, the second color, and the third color;
continuously measuring the fluid level in the fluid vessel and determining a second level of liquid within the fluid vessel;
updating the assigning of the color to the second level of liquid within the fluid vessel;
changing the illuminating the fluid vessel with the one of the first color, the second color, and the third color based on the second level of liquid within the fluid vessel.

8. The method of claim 7 and further comprising the step of activating the fluid vessel.

9. The method of claim 8 wherein activating the fluid vessel further comprises the step of moving the fluid vessel, providing an accelerometer to record a linear movement of the fluid vessel, and activating the fluid vessel when the linear movement exceeds a predefined threshold.

10. The method of claim 9 wherein activating the fluid vessel further comprises the step of moving the fluid vessel, providing a gyroscope to record a rotational movement of the fluid vessel, and activating the fluid vessel when the rotational movement exceeds a predefined threshold.

11. The method of claim 10 and wherein the measurements provided by the plurality of sensor plates to create the liquid level reading comprises the further step of being provided simultaneously.

12. The method of claim 11 and further comprising the step of defining the level of liquid within the fluid vessel between an empty liquid level of zero percent and a full liquid level of one-hundred percent.

13. The method of claim 12 and further comprising the step of providing a vibration motor device in the fluid vessel and creating a pulse in the fluid vessel.

14. The method of claim 13 and further comprising the step of creating the pulse in the fluid vessel upon completion of a sequence of a plurality of movements of the fluid vessel.
